(19) United States
(12) Patent Application Publication
(10) Pub. No.: US 2015/0226247 A1
(43) Pub. Date: Aug. 13, 2015

(54) ROOF PANEL EDGE SUPPORT

(71) Applicant: DOW GLOBAL TECHNOLOGIES LLC, Midland, MI (US)

(72) Inventors: Stephen G. Pisklak, Hockessin, DE (US); Joseph A. Langmaid, Caro, MI (US); Timothy J. Buscarino, Saginaw, MI (US); Gerald A. Eurich, Merrill, MI (US)

(21) Appl. No.: 14/425,518

(22) PCT Filed: Aug. 14, 2013
(86) PCT No.: PCT/US13/54903

§ 371 Date: Mar. 3, 2015

Related U.S. Application Data
(60) Provisional application No. 61/707,179, filed on Sep. 28, 2012.

(51) Int. Cl. F16B 5/06; E04B 1/61

(52) U.S. Cl. CPC F16B 5/0635; E04B 1/6116

(57) ABSTRACT

A device comprising: a first part having a shape so that the first part is fully and/or partially insertable through a seam between two adjacent panels and a second part having a shape so that the second part is at least partially insertable through the seam between the two adjacent panels; wherein the first part and the second part are connected together via a connection region and wherein the first part, the second part, or both when extended through the seam between the two adjacent panels simultaneously engages both of the two adjacent panels so that movement of a first panel is transferred to a second panel or vice versa, via the multi-part device, and deflection of the first panel, the second panel, or both is minimized and/or substantially eliminated.

### FIELD

The present teachings generally relate to a support that connects two adjacent panels, and more specifically a support that can be added between to adjacent panels while the panels are in a fixed position.

### BACKGROUND

Roofs on homes and buildings generally are formed by adding a plurality of pieces of panels together so that one generally contiguous roofing surface is formed. The plurality of pieces of panels are supported by one or more support beams. These support beams may be spaced apart so that the roof provides adequate structure to support the plurality of pieces of panels, shingles, and other standard roofing components. The support beams may be spaced apart so that the roof has load bearing characteristics for normal roofing components and when additional weight is applied to the roof, the plurality of pieces of panels deflect so that one piece may extend below another piece. Some deflection is acceptable for normal roofs as additional weight is infrequently added to the roof and the components of the roof are capable of moving during this deflection without being damaged. However, if while building a roof it is contemplated that additional load bearing capabilities will be expected of the roof, such as adding solar modules, the support beams may be built closer together so that deflection of the plurality of pieces of panels is minimized and/or eliminated.

Generally, however, a roof is built and it is later decided that additional load bearing capabilities are needed. in the event that additional load bearing capabilities are needed the roof is typically taken apart so that additional support can be added to the plurality of panels. in some instances when the plurality of panels are removed additional support beams are added to the roof so that the deflection is substantially reduced and/or eliminated, In other instances, panels may be removed so that support brackets may be added between two adjacent pieces of panels so that the two adjacent panels are connected and deflection is substantially reduced and/or eliminated. Examples of some known edge supports that may be added between two adjacent pieces of panels may be found in U.S. Patent Nos. D260481, 3,297,345; 4,703,603; 4,729,197; 5,517,731, 5,966,893; 6,301,856; 7,444,792; and 7,784,755; and U.S. Patent Application Publication No, 2008/0250742, all of which are incorporated by reference herein for all purposes. Currently, adding either supports or additional trusses require that the plurality of pieces of panels are removed which is expensive and time consuming.

It would be attractive to have a device that provides additional bad being capabilities without having to disassemble all or a portion of a roof. It would be attractive to have a device that can be added between two adjacent pieces of panels that couples the edges of two adjacent pieces of panels together and substantially eliminates deflection of the pieces of panels relative to each other, It would be attractive to have an inexpensive device that can be added to an existing roof structure by a single installer.

### SUMMARY

The present teachings meet one or more of the present needs by providing: a device comprising: a device comprising: (a) a first part having a shape so that the first part is fully and/or partially insertable through a seam between two adjacent panels and (b) a second part having a shape so that the second part is at least partially insertable through the seam between the two adjacent panels; wherein the first part and the second part are connected together via a connection region and wherein the first part, the second part, or both when extended through the seam between the two adjacent panels simultaneously engages both of the two adjacent panels so that movement of a first panel is transferred to a second panel or vice versa, via the multi-part device, and deflection of the first panel, the second panel, or both is minimized and/or substantially eliminated.

One possible embodiment of the present teachings include: a device comprising: a first part comprising: a connecting region and two spaced apart support regions, wherein the connecting region is located between the two support regions and the two support regions are substantially parallel, a second part comprising: a connecting region and two spaced apart support regions, wherein the connection region is located between the two support regions and the two support regions are substantially parallel; wherein the first part and the second part are adapted to extend through a seam between two adjacent panels and connect via the connection region so that one of the two spaced apart support regions of the first part and the second part are located above one of the two adjacent panels, and one of the two spaced apart support regions of the first part and the second part are located below one of the two adjacent panels.

One possible method for installing a clip includes: placing the device taught herein in the seam between two adjacent panels and securing the first part and the second part together so that the device restricts movement of the two adjacent panels relative to each other.

The teachings herein surprisingly solve one or more of these problems by providing a device and/or method that provides additional load being capabilities without having to disassemble all or a portion of a roof. The teachings herein are a device that can be added between two adjacent pieces of panels that couples the edges of two adjacent pieces of panels together and substantially eliminates deflection of the pieces of panels relative to each other. The teachings herein are an inexpensive device that can be added to an existing roof structure by a single installer.

### BRIEF DESCRIPTION OF THE DRAWINGS

FIG. 1 illustrates an exploded view of one possible embodiment of the device taught herein;

FIG. 2 illustrates a perspective view of FIG. 1;

FIG. 3A-3C illustrate a sequence of the device being inserted into a gap between two adjacent panels;

FIG. 4 illustrates a top view of the device;

FIGS. 5A-5G illustrate a sequence of installing one possible embodiment of the device being inserted in a gap between two adjacent panels;

FIG. 6 illustrates a perspective view of half of another embodiment of the device taught herein;

FIG. 7 illustrates a side view of the device taught herein;

FIG. 8 illustrates a top view of another embodiment of the device taught herein;

FIG. 9 illustrates a cross-sectional view of the device during a force apply; and

FIG. 10 illustrates an example of a roof with solar modules.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims. which are also hereby incorporated by reference into this written description.

The device as taught herein is a multi-piece device. The multi-piece device includes at least two discrete pieces. The at least two discrete pieces include a first part and a second part. The first part may be any size and shape so that the first part is extendable and/or insertable through a gap between two adjacent panels. The first part may have any shape or size so that all or a portion of the first part extends between a gap and the first part contacts both a first panel and a second panel. The first part may contact both the first panel and the second panel on the top side, the bottom side, or both. In one preferred embodiment, the first part may contact one top side and one bottom side of two adjacent panels. The first part may be free of contact with the edges of the two opposing panels. For example, the first part may extend fully through the gap so that the entire first part is disposed below the two adjacent panels. The first part may contact the edges of the two opposing panels proximate to the gap. For example, the first part may extend partially though the gap so that a portion is located above the two adjacent panels, a portion is located below the two adjacent panels, and a portion is located between the two adjacent panels. The first part may include one or more regions.

The first part preferably includes one or more support regions and at least one connection region, More preferably, the first part includes two or more support regions and one or more connection regions, The one or more support regions may be any region that directly contacts one or more surfaces of a panel. The one or more support regions may be any part of the device that supports one or more edges of the panels so that deflection of one or both panels are reduced and/or substantially eliminated. The one or more support regions may be any part of the device that contacts at least one surface of a panel and resists deflection, assists in resisting deflection, provides support, counteracts deflection, maintains the edges of the two adjacent panels substantially in the same plane, or a combination thereof. The one or more support regions may create and/or provide a one or more reactionary forces. For example, during a deflection the panel may be pushed down and begin to deflect, and the support region will provide a reactionary force up so that movement of the panel down is reduced and/or substantially eliminated. The one or more support regions may be any region of the device that is substantially parallel to one or more panels. The one or more support regions may be angled so that an end of the support region is angled towards the panel so that at least a portion of the support region is in contact with the panel during a rest position, a deflection position, or a position therebetween. The one or more support regions may be angled so that the device once connected is in tension and/or compression so that the two adjoining panels move substantially in unison. The support regions may form an angle with a plane parallel to a panel of about 5 percent or less. about 3 percent or less, or about 1 percent or less. The support regions may form an angle with a plane parallel to a panel of about −5 percent or less, about −3 percent or less, or about −1 percent or less. The one or more support regions may include one or more grippers.

The grippers may be any part of the support regions that connects the device to the two adjacent panels. The grippers may be any part of the support regions that prevents the support regions from rotating, being disconnected from the panels, twisting, or a combination thereof during installation, use, or both. The grippers may extend from the support regions at any location along the length of the support regions. The grippers may grip the panels without damaging the panels. Preferably, the grippers grip the panels by all or a portion of the gripper being embedded within the panels so that the grippers maintain the position of the device relative to the panels, the device moves with the panels, movement of the device independent of the panel is substantially reduced and/or eliminated, or a combination thereof. The grippers may be any size and shape so that the gripper functions to restrict movement of the device independent of the panels. The grippers may be triangular, half circular, square, pencil shaped, or a combination thereof. Preferably, the grippers extend from the ends of the support regions. The connection regions may be free of grippers.

The one or more connection regions may be any portion of the first part that connects the first part to the second part. The one or more connection regions may be any size and shape so that a first part and a second part are connected. The one or more connection region may be located anywhere along the length of the first part. Preferably, the one or more connection regions are located between two adjacent support regions. The one or more connection regions may form any angle with the support regions so that the connection region assists the support regions in supporting adjacent panels. The one or more connection regions and the one or more support regions may form any angle so that the support regions, the connection regions, or both extend into and/or through a gap between two adjacent panels. The one or more connection regions and the one or more support regions may form an angle of about 30 degrees or more, about 45 degrees or more, about 60 degrees or more, or about 75 degrees or more. The one or more connection regions and the one or more support regions may form an angle of about 270 degrees or less, preferably about 235 degrees or less, more preferably about 205 degrees or less, or most preferably about 185 degrees or less. The one or more connection regions and the one or more support regions may form an angle from about 200 degrees to about 75 degrees and preferably from about 185 degrees to about 90 degrees, The connection region may extend through the gap when the device is in an installed position. The connection region may be located adjacent to the gap when the device is in the installed position. The connection region may include one or more connectors for attaching the first part to the second part. The connection region may include a torque transfer surface, an interlock, a threaded connector, a geared surface, or a combination thereof,

The interlock may be any feature that connects the first part and the second part and assists in reducing and/or substantially eliminating deflection. The interlock may be any size and shape so that the first part and the second part when connected are substantially flush with each other. The interlock may be any feature that may form a mechanical connection between the first part and the second part. The interlock may be any feature that surrounds or is surrounded by an opposing part so that the first part and the second part are connected. The interlock may form a movable connection, a fixed connection, a rotatable connection, an adjustable connection, or a combination thereof between the first part and the second part. The interlock may be a hole, a groove, a series of apertures, a cut, an absence of material, or a combination thereof that accepts an adjoining component so that a connection between the first part and the second part are formed. The interlock may allow the first part, the second part, or both to twist relative to each other, a panel, or both so that the first part and the second part may be connected and the device may assist in preventing and/or eliminating deflection. The interlock may include a twist so that the interlock may easily connect a first part to the second part. The twist may allow one part of the interlock to extend over and/or under the corresponding portion of the interlock on the opposing part so that the parts lock together. Each portion of the interlock may twist by about 1 degree or more, about 3 degrees or more, or about 5 degrees or more from the connection region plane. Only the interlock may be twisted and the torque transfer surface may be free of twist. Each portion of the interlock may twist by about 10 degrees or less, about 7 degrees or less, or about 6 degrees or less. Each portion may twist by more than 0 degrees, about 1 degree or more, about 2 degrees or more, or about 3 degrees or more.

The twist may be a first side of the interlock being offset from the second side of the interlock. The twist may be a top interlock part and/or a bottom interlock part extending so that the top interlock part and the bottom interlock part are not located in the same plane. The twist may be any shift “out of plane” so that the first part may easily be connected with the second part via the interlock. For example, a shift out of plane may be one or both sides of the interlock extending above and/or below a plane defined by the connection region, thus, when viewing the interlock and connection region plane, at a side view, one portion of the interlock may extend above the plane and another portion may extend below the plane so that the interlock is “twisted.” The top interlock part, the bottom interlock part, the torque transfer surface, or a combination thereof may be in the connection region plane or twisted out of the connection region plane.

The torque transfer surface may be any surface that extends into the interlock, surrounds the interlock, is proximate to the interlock, or a combination thereof. For example, the torque transfer surface may be substantially surrounded by the interlock so that the interlock contacts the torque transfer surface during movement and the torque transfer surface prevents further movement of the interlock. The torque transfer surface may be any part that contacts a top interlock part, a bottom interlock part, or both so that the device prevents deflection. The torque transfer surface may be configured so that when in communication with the interlock the first part and second part have flush edges. The torque transfer surface may be any portion of the device that is located between the two adjacent panels (e.g., in the gap). The torque transfer surface may be substantially planar. Preferably, the torque transfer surface is in the connection region plane and the top interlock part, the bottom interlock part, or both extend out of plane towards the torque transfer surface so that, when connected, the device assists in resisting deflection. The first part, the second part, or both may include a torque transfer surface. Preferably, both the first part and the second part have a torque transfer surface. The torque transfer surface of the first part, the second part, or both may be substantially parallel, may be angled towards each other, may be angled away from each other, or both when the first part and the second part are connected. The torque transfer surface of the first part and the second part when connected may be substantially coplanar when viewed from a side view so that the torque transfer surface resists movement of the two adjacent panels, resist movement relative to each other, have little movement before the two torque transfer surfaces contact, or a combination thereof. The first part. the second part or both may be free of a torque transfer surface,

The first part, the second part, or both may be connected using any device that secures the first part to the second part so that the first part, the second part or both substantially reduce and/or prevent deflection of the edges of two adjacent panels. The first part, the second part, or both may be insertable and/or extendable through a gap between two adjacent panels. The first part, the second part, or both may consist of two or more parts connected together so that at least one part extends through the gap between two adjacent panels and connects the first part to the second part. The second part may have two pieces.

The second part may be any size and shape so that all or a portion of the second part extends into a gap between two adjacent panels. The second part may be identical to a first part and the discussion herein regarding the first part is incorporated by reference herein with regard to the second part. The second part may be partially and/or fully insertable into a gap. The second part may partially and/or fully extendable into a gap. The second part may include a portion that remains in the gap when the device is assembled and in a deployed position. The second part may be configured so that the device is either capable of being inserted fully through the gap or capable of preventing insertion and/or removal through the gap. Preferably, the second part includes a portion that is configured so that the device is prevented from being inserted into and/or extending into virtually any gap. The second part may include a portion that is substantially flat so that the second part can fit through virtually any gap, between virtually any two adjacent panels, or both. The second part may include a support piece and a connection shaft.

The support piece may be any part that resides substantially above and/or substantially below two adjacent panels and substantially prevents the device from being moved through a gap, substantially prevents the edges of the two adjacent panels from deflecting, attaching the first piece to the second piece, or a combination thereof. The support piece may be any size and shape so that the support piece substantially prevents deflection of two adjacent panels, the support piece supports the device, the support piece connects to the connection shaft, the support piece prevents the device from being moved through a gap, or a combination thereof. The support piece may be square, round, rectangular, diamond, “x” shaped, or a combination thereof, The support piece may include a through hole for a connection shaft to pass through and/or attach to so that the support piece and the connection shaft are connected. The support piece includes one or more support regions and one or more connection regions.

The support regions may be located anywhere along the support piece, the first part, the second part, or a combination thereof. The support regions as discussed herein may be any part of the support piece, the first part, the second part, or a combination thereof where the support piece contacts one or more adjacent panels. The support regions may be any region that prevents the support piece, the first part, the second part, or a combination thereof from passing through the gap when the device is attached. The support region may be any region that contacts two adjacent panels and assists in preventing the panels from deflecting. The support region may have a sufficient size and shape so that the device is prevented from moving through a gap and so that the device assists in substantially reducing and/or eliminating deflection of the edges of two adjacent panels. The support region may be substantially circular, oval, square, rectangular, elongated, symmetrically shaped, asymmetrically shaped, or a combination thereof and may contact two adjacent panels simultaneously. The support region may be located proximate to a connection region. Preferably, a connection region is located between two or more support regions or is substantially surrounded by a support region. The support region may be toroidally shaped with the connection region in the center.

The connection region may be located anywhere along the support piece, the first part, the second part, or a combination thereof. The connection region may be any part of the device where the first part and the second part connect together. The connection region of the support piece may be an absence of material (e.g., a through hole). The connection region may be any size and shape so that the connection region may support a connection between the first part and the second part and so that the device substantially prevents and/or eliminates deflection of two adjacent panels. The connection region may be located within the same plane as the support region. The connection region may be located above or below the support region. The connection region may have any configuration that corresponds with a connection shaft so that the support piece and the connection shaft may be connected together. For example, the connection shaft may be a threaded male connection and the support piece may be a threaded female connection or the connection shaft may have an expanded end and the support piece may have a through hole that is larger than the body of the connection shaft and smaller than the end of the connection shaft.

The support piece and the connection shaft may rotatably connect. For example, the support piece, the connection shaft, or both may rotate while the support piece and the connection shaft are connected. The support piece may be any piece that has sufficient size and strength so that the support piece supports the connection shaft, resists deflection of two adjacent panels, prevents the device from moving through the gap, or a combination thereof.

The connection shaft may be any device that connects the first piece to the second piece. The connection shaft and the support piece may be one integral part. Preferably, the connection shaft and the support piece are two discrete parts. The connection shaft may be any size and shape so that the connection device connects to the first part and the second part and at least a portion of the connection shaft extends through a gap between two adjacent panels. The connection shaft may attach to the first part, the second part, or both, using the same connection device, different connection devices, or a combination of devices. The connection shaft may include any attachment device so that the connection shaft is rotatably attached, fixedly attached, removably attached, permanently attached, or a combination thereof to the first part, the second part, or both. The connection shaft may be threaded, have a large end portion and smaller body portion, be expandable, be contractible, include a spring loaded feature, a mushroom feature, one or more ribs for a feature of the first part, the second part, or both to grip, or a combination thereof. The connection shaft may be any shape and size so that the connection shaft may pass through a gap between two adjacent panels. The connection shaft may be round, oval, square, flat, or a combination thereof. The shape of the connection shaft may vary from a first end proximate to a first part to a second end proximate to a second part.

The first part, the second part, or both may be made of any material hat assists in preventing deflection, substantially prevents deflection, eliminates deflection, or a combination thereof between two adjacent panels. The first part, the second part, or both may be made of the same material, a different material, or a combination of materials The first part, the second part. or both may be made of any material that is plastically deformable. elastically deformable, has a high bending strength, a high compressive strength, or a combination thereof. The first part, the second part, or both may be made of a natural material, a synthetic material, a plastic material, a metallic material, a composite material, or a combination thereof. Preferably, the first part, the second part, or both are made of a material that is resistant to corrosion, structural failure, fatigue, or a combination thereof. Most preferably, the first part, the second part, or both are made of galvanized steel. The first part, the second part, or both may be made of any material that may fit between two adjacent panel, connect two adjacent panels, prevent deflection of two adjacent panels, or a combination thereof.

The panels may be any part of a structure, Preferably, panels as discussed herein may be part of a roof. The panels may be any panel that may be used with solar modules. The panels may be any panel that may have sufficient strength to support the mass of a solar module, solar module components, solar module connectors, integrated flashing pieces, any component of a solar module, the like, or a combination thereof. The panels may be any size and shape so that the panels when placed proximate to each other form one contiguous surface. The panels may be made of made of any material that may support one or more solar module, solar module components, solar module connectors, integrated flashing pieces, any component of a solar module, the like, or a combination thereof. The panels may be made of wood, plywood, structural plywood, decorative plywood, overlaid plywood, commercial plywood, utility plywood, marine plywood, medium density fiberboard (MDF), oriented strand board (OSB), Sundela, hardboard, insulation board, the like, or a combination thereof.

The device may be used in a method discussed herein. The method may include one or more of the steps listed herein performed in virtually any order The method includes obtaining a first part and a second part. The first part may be secured to the second part. The first part may be placed proximate to a gap. The first part may be inserted into the gap. The first part may be inserted through the gap so that the first part is completely located below the two adjacent panels. The first part may be inserted into the gap so that part of the first part is located above the panels, part of the first part is located below the panels, and part of the first part is located between the panels. The second part may be inserted into the gap so that part of the second part remains in the gap and part of the second part remains above the two adjacent panels. The second part may be inserted into the gap so that part of the second part is located above the panels, part of the second part is located below the panels, and part of the second part is located between the panels. The first part, the second part, or both may be rotated so that the first part forms an angle with the gap. Preferably, the first part is rotated so that the first part forms an angle with the gap from about 15 degrees to about 165 degrees, and preferably substantially a right angle. The first part, the second part or both may be rotated so that the support regions of the first part, the second part, or both are rotated towards the panels. For example, during the step of inserting the first part, the second part, or both may be vertically oriented with regard to the panels and as the first part, the second part, or both extend through and/or are inserted into the gap the first part, the second part or both may be rotated towards the panels. The first part, the second part, or both may be rotated so that the support regions are in a working position (e.g., substantially parallel to the panels, angled towards the panels, angled away from the panels, or a position therebetween). The first part, the second part, or both may be pulled up so that the first part contacts one or both of the two adjacent panels. The first part, the second part, or both may be pulled up so that one or both grippers are embedded into one or both of the two adjacent panels. The first part, the second part, or both may be rotated so that the distance between the first part and the support piece is reduced so that both the first part and the support piece simultaneously contact the two adjacent panels. The first part and the support piece may be maintained static and the connection shaft may rotate so that the distance between the first pail and the support piece is reduced so that both the first part and the support piece simultaneously contact the two adjacent panels. The first part, the second part, or both may be moved laterally along the length of the gap towards each other. The first part, the second part, or both may be moved sequentially and/or simultaneously into contact so that the first part and the second part are fixedly connected via an interlock, During the step of connecting the first part and the second part may be rotated so that the interlocks, the torque transfer surfaces, the top interlock part, the bottom interlock part, or a combination thereof align. The first part, the second part, or both may be twisted during the step of connecting so that the top interlock part may go over and/or under the bottom interlock part of the respective opposing first part or second part so that a connection may be formed. The first part, the second part, or both may be installed between existing panels, mounted panels, static panels, immobilized panels, or a combination thereof. The method may be free of one or more and preferably all of the following steps: removing nails, removing screws, unattaching all or a portion of one or more panels, prying up a panel to increase the size of the gap, pounding the device into a gap, or a combination thereof. The method may include attaching one or more solar modules, one or more solar modular connectors, one or more integrated flashing pieces, or a combination thereof to the panels so that a partial and/or full solar array is created.

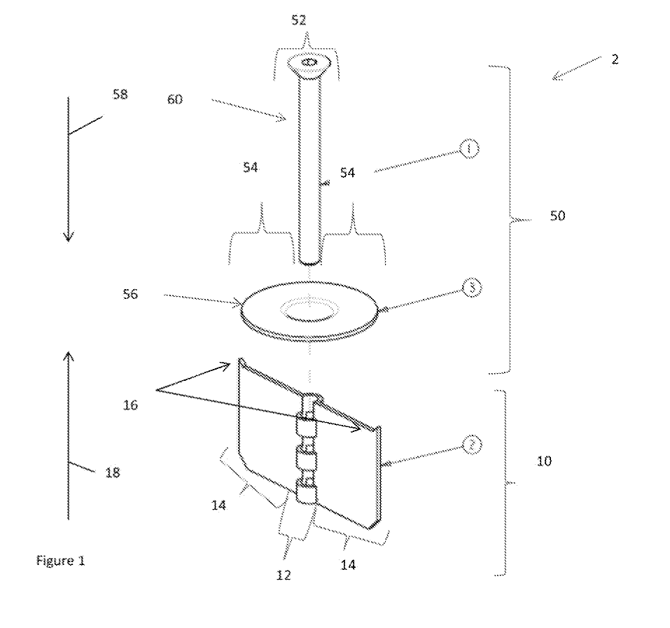

FIG. 1 illustrates an exploded view of one embodiment of the teachings herein. The device 2 includes a first part 10 and a second part 50. The first part 10 has a connection region 12 located between two support regions 14. The two support regions 14 prevent the device 2 from moving in the direction indicated by arrow 18 by contacting two adjacent panels 90 (not shown). Each support region 14 includes a gripper 16 for preventing movement of the device 2 when in a deployed state. The second part has a connection region 52 located between two support regions 54. The second part 50 has a connection shaft 60 and a support piece 56. The support piece 56 prevents the device 2 from moving in a direction indicated by arrow 58 by contacting two adjacent panels 90 (not shown),

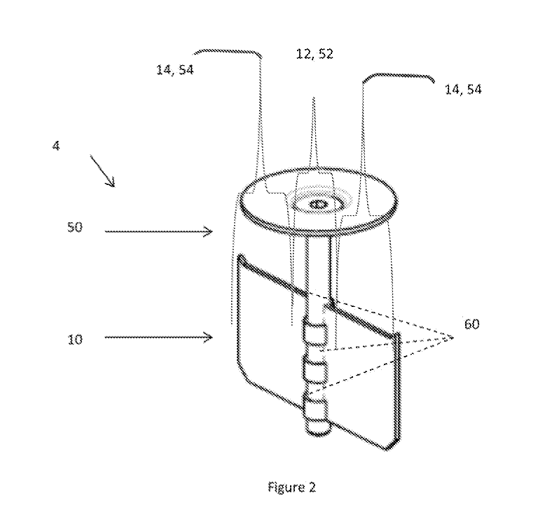

FIG. 2 illustrates a perspective view of an assembled device 4. As illustrated the first part 10 and the second part 50 are connected via the connection shaft 60. When assembled, connection regions 12 and 52 are aligned and the support regions 14 and 54 are aligned so that two adjacent panels 90 (not shown) are supported therebetween.

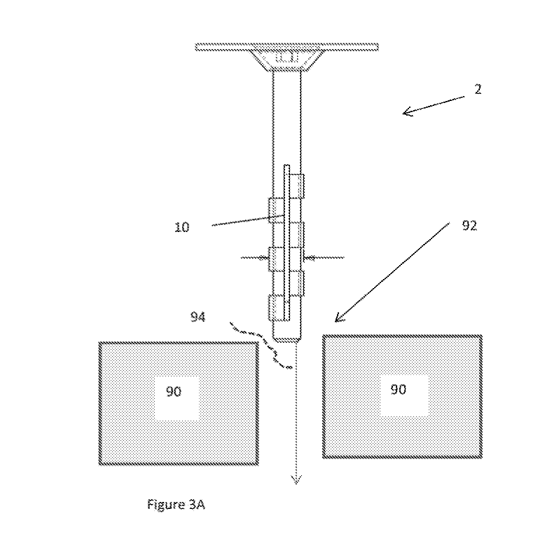

FIGS. 3A-3C illustrate a sequence of inserting the device 2 into a gap 92 between two adjacent panels 90. As is illustrated in FIGS. 3A-3C the panels 90 and the gap are not to scale and are shown for illustrative purposes only,

FIG. 3A shows the first part 10 extending into the gap 92 between the two adjacent panels 90 in the direction 94.

FIG. 3B illustrates the device 2 fully inserted into the gap 92 so that the second part 50 contacts the two adjacent panels 90, The device when fully inserted in the gap 92 is rotated in the direction 96 so that the first part 10 is substantially perpendicular to the gap 92

FIG. 3C illustrates a side view of the device 2 with the first part 10 perpendicular to the gap 92 between the two adjacent panels 90. The first part 10 includes grippers 16 that are moved in the direction 98 so that the grippers 16 contact the two adjacent panels 90 so that further movement is prevented. The grippers 16 prevent rotation of the device so that the gap 100 may be reduced and the two adjacent panels 90 are held between the first part 10 and the second part 50 so that the device 2 prevents independent movement of the two adjacent panels 90,

FIG. 3C further illustrates the interrelationship between the device 2 and the two adjacent panels 90 during an increase in force, As a force (F) is placed on one of the two adjacent panels 90 the panel begins to deflect. As the panel begins to deflect due to force (F) the device 2 creates a reactionary force (RF) that opposes the deflection by the force (F). The reactionary force (RF) is created by the device 2 creating a device force (DF) on the second of the two adjacent panels 90 so that the second panel provides support and assists in creating the reactionary force (RF) on the first panel through the device 2.

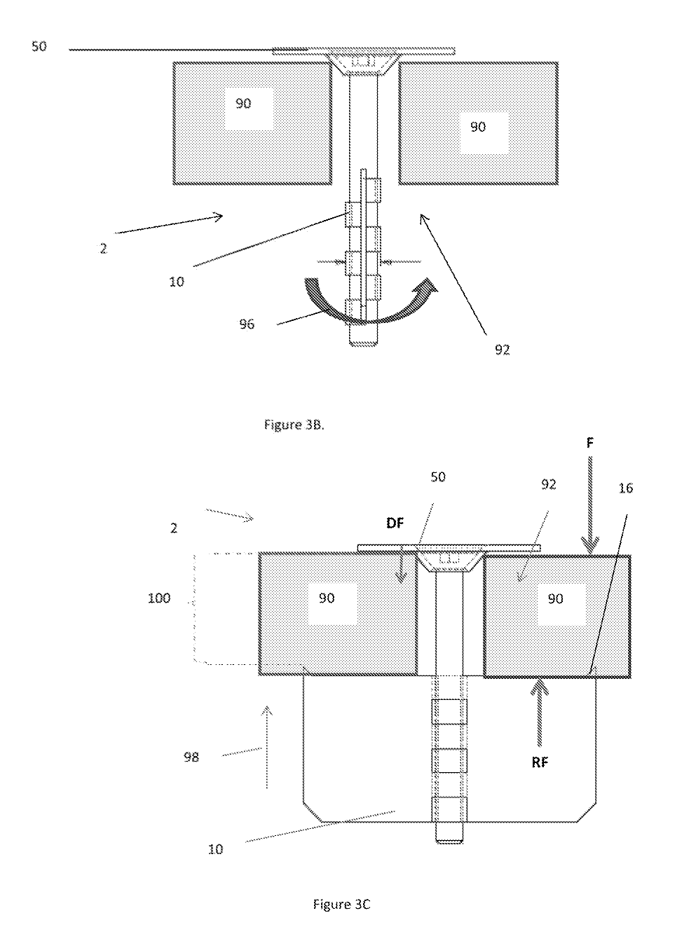

FIG. 4 illustrates a top view of the device 2. The device includes a first piece 10 that extends beyond a second piece 50. The second piece 50 includes a connection shaft 60 that is movable so that the distance 100 (now shown) between the first piece 10 and the second piece 50 may be reduced.

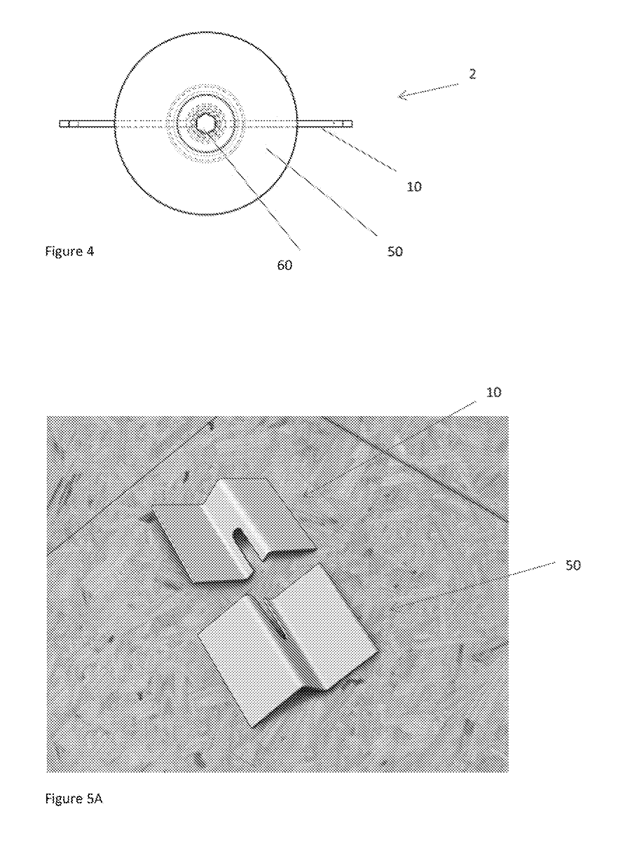

FIGS. 5A-5F illustrate a sequence of inserting the device 2 into a gap 92. As illustrated in FIGS. 5A-5F the panels 90 and gap 94 are not to scale and are shown for illustrative purposes only, normally the panels 90 will be located closer together as is illustrated in FIGS. 5E and 5R.

FIG. 5A illustrates a first part 10 and a second part 50 oriented relative to each. other before being inserted into a gap.

FIG. 58 illustrates the first part 10 being inserted into the gap 92 between the two adjacent panels 90. Optionally, as illustrated a force may be applied to one of the panels 90 during insertion to assist the first part 10 into the gap 92. The first part 10 extends through the gap 92 in the direction 94 and then rotated in the direction 96 so that a support region 14 is located above one of the two adjacent panels 90 and another support region 14 is located below one of the two adjacent panels 90.

FIG. 5C illustrates the first part 10 in an installed position before the first part 10 is connected to a second part (not shown). The first part 10 is extended through the gap 92 between the two adjacent panels 90. The twist of the first part 10 is shown with the top interlock part 122 and the bottom interlock part 124 oriented away from each other. The support regions 14 on each side of the connection region 14 are in contact with one of the two adjacent panels 90 so that when fully installed the device will assist in minimizing deflection between the two adjacent panels.

FIG. 5D illustrates the second part 50 being inserted into the gap 92 between the two adjacent panels 90. Optionally, a force may be applied to one of the two adjacent panels 90 increasing the size of the gap 92 so that the second part 50 may be more easily installed. The second part 50 extends through the gap 92 in the direction 94 and is rotated in the direction 96 so that a support region 14 is located above one of the two adjacent panels 90 and another support region 14 is located below one of the two adjacent panels 90. The first part 10 and the second part 50 are arranged so that a first part is above one panel 90 and the second part 50 is below the same panel 90 and vice versa.

FIG. 5E illustrates a top view of the first part 10 and the second part 50 installed in the gap 92 between the two adjacent panels 90 as is illustrated in FIGS. 5B-5D. To complete the installation, the first part 10 is moved in the direction 102 and/or the second part 50 is moved in a second direction 104 so that the first part 10 and the second part 50 interlock.

FIG. 5F illustrates a top view of an assembled device 4. The assembled device 4 has the first part 10 and the second part 50 interlocked in the gap 92 between the two adjacent panels 90 so that the edges of the two adjacent panels 90 are held in place and deflection of the panels is minimized.

FIG. 5G illustrates a cross-sectional view of the assembled device 4 of FIG. 5F. As illustrated, in FIGS. 5E and 5F the first part 10 moves in the direction 102 towards the second part 50 and/or the second part 50 moves in the direction 104 towards the first part 10 along the gap 92 until the first part 10 and the second part 50 connect. The device 2 holds the ends of the two adjacent panels 90 so that any force applied on the ends of the two adjacent panels pushes the torque transfer surfaces 20 and 62 together so that movement of the ends of the two adjacent panels 90 relative to each other is limited.

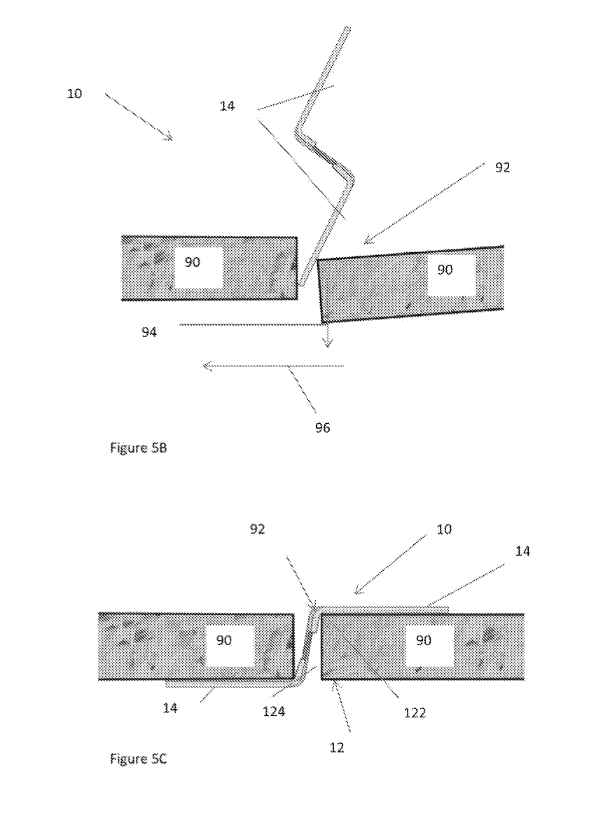

FIG. 6 illustrates a first part 10 and/or a second part 50. The first part 10 and/or the second part 50 includes a connection region 12, 52 and two support regions 14, 54. The connection region 12, 52 and support regions 14, 54 form an angle (α). The connection region 12, 52 includes a torque transfer surface 20, 62 for contacting an opposing torque transfer surface 20, 62 respectively so that movement of the device and ends of panels (not shown) are minimized. The connection region 12. 52 includes an interlock 22, 64 for attaching to a corresponding interlock 22, 64 of an adjoining first part 10 or second part 50.

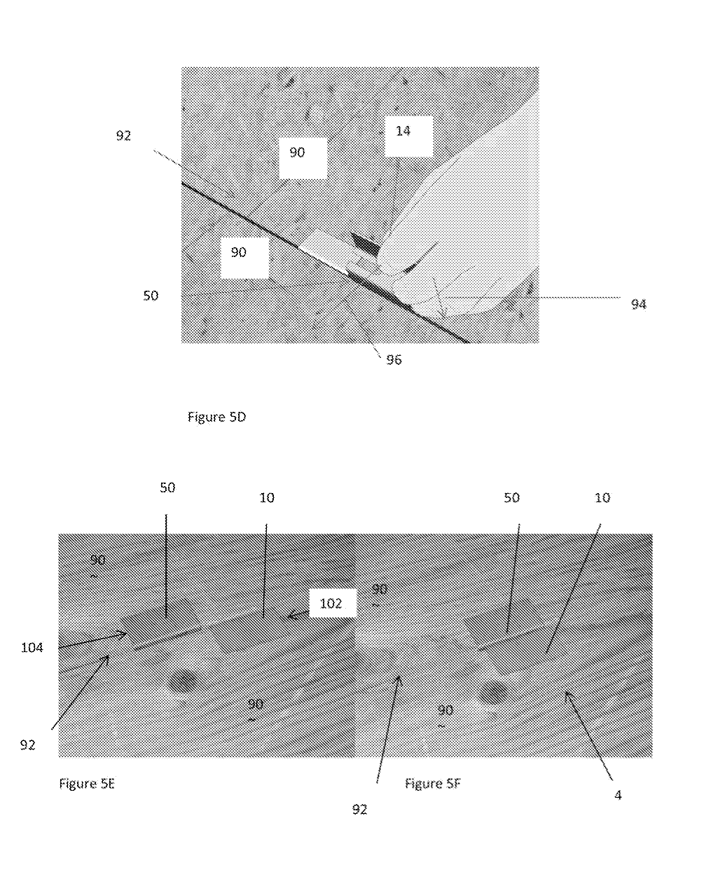

FIG. 7 illustrates a side view of the connection regions 12, 52 of FIG. 56, and the torque transfer surfaces 20 and 62 of the first part 10 and the second part 50 respectively. The torque transfer surfaces 20 and 62 are twisted and form an angle (β) when the device 2 is assembled.

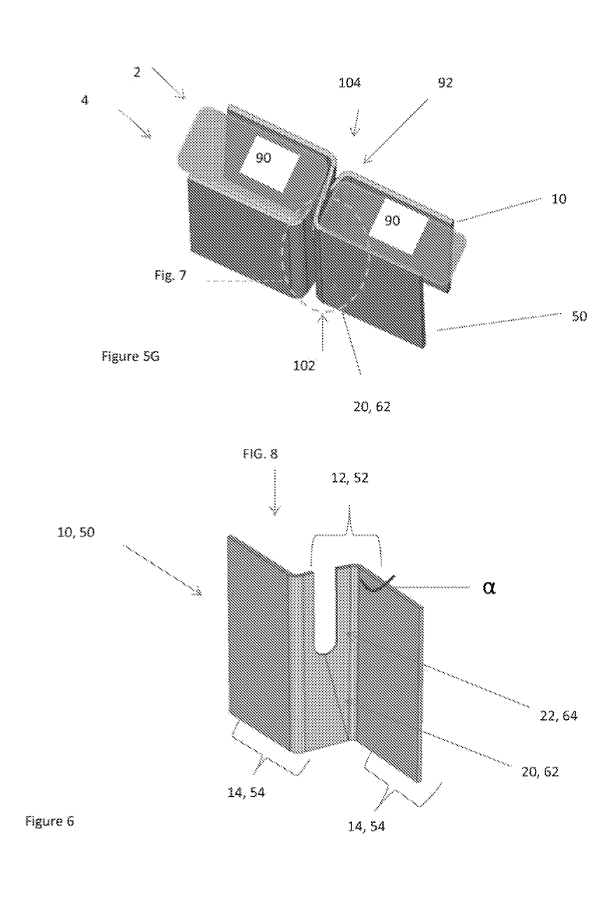

FIG. 8 illustrates the device 2 of FIG. 6 illustrated from a top view. As illustrated the twist of the connection region 12, 52 is visible. The connection region 12, 52 is located between the support regions 14. 54. The connection region 12, 52 has a connection region plane 120, and the top interlock part 122 and the bottom interlock part 124 extend out of the connection region plane 120 by an angle (θ) so that the top interlock part 122 and the bottom interlock part 124 assist in connecting during attachment of a first part to a second part. During connection of the first part (not shown) to the second part (not shown), the top interlock part 122 and the bottom interlock part 124 will cause the support regions 14, 54 to twist towards a panel 90 as is illustrated in FIG. 7 so that the panels 90 are gripped between the support regions 14, 54 of the first part and the second part.

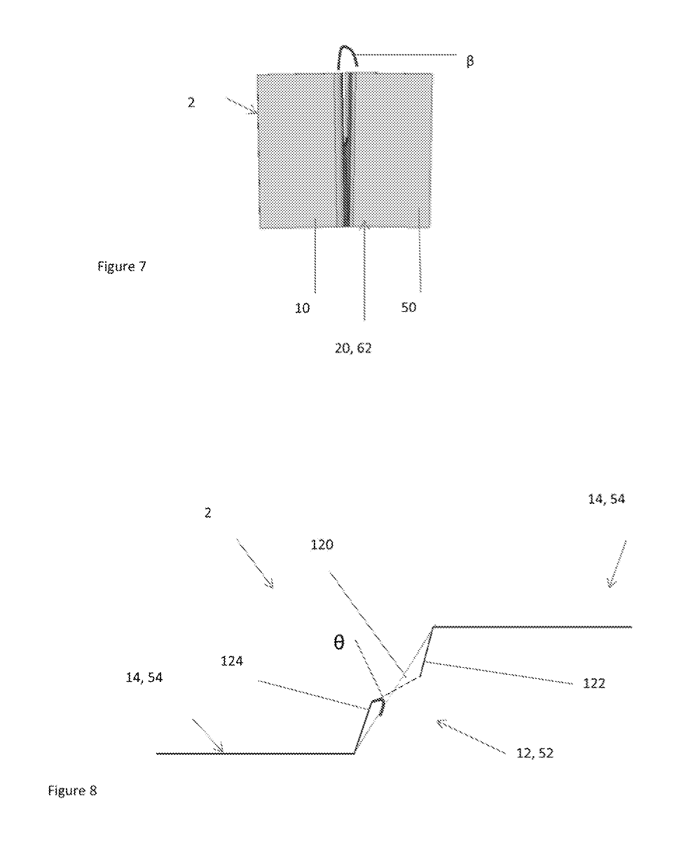

FIG. 9 illustrates a cross section of an assembled device 4 installed between two adjacent panels 90. The first part 10 and the second part 50 are connected together so that when a force (F) acts on the first part 10 some force is transferred to the second part 50 and vice versa. As illustrated a force (F) is being applied to the second part 50. As the second part 50 begins to deflect the first part 10 creates a reactionary force (RE) opposing the deflection. As the first part 10 begins to deflect the first part's torque transfer surface 20 and the second part's torque transfer surface 62 contact each other so that a torque transfer force (TTF) is created that substantially prevents movement of the first part 10. The force (F) moves the second part 50 up so that a device force (OF) is applied to the second panel, and the panel applies a second reactionary force (RF2) so that movement of the device and the first panel independent of the second panel is substantially prevented.

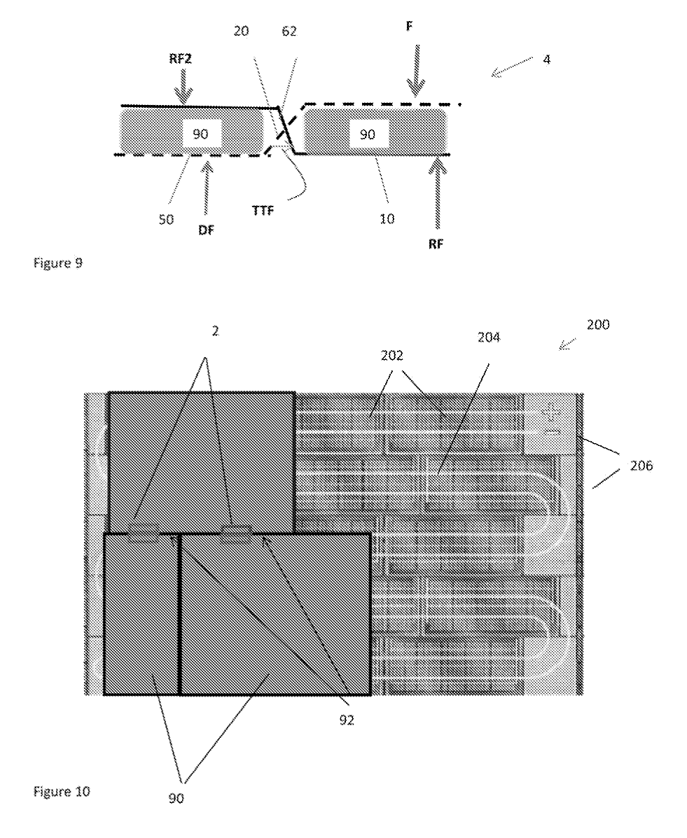

FIG. 10 illustrates a roof 200 with half of the solar modules 202 cut away so that the panels 90 and devices 2 are exposed that are below the solar modules 202. As illustrated, two devices 2 are installed in gaps 92 between the two adjacent panels 90. Illustrating two devices 2 are merely intended to illustrate the device 2 installed and are not intended to limit the use of the device 2. More or less devices may be used as needed. Half of the roof 200 includes solar modules 202, solar module connectors 204, and integrated flashing pieces 206 installed over a roof 200 where the panels 90 include the devices 2 taught herein.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive, Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1) A device comprising:
a. a first part having a shape so that the first part is fully and/or partially insertable through a seam between two adjacent panels that are part of a pre-existing roof and
b. a second part having a shape so that the second part is at least partially insertable through the seam between the two adjacent panels that are part of the pre-existing roof;
wherein the first part and the second part are both insertable into the seam of the two adjacent panels from a same side without removing any panels of the pre-existing roof
wherein the first part and the second part are connected together via a connection region;
wherein the first part, the second part, or both when extended through the seam between the two adjacent panels simultaneously engage both of the two adjacent panels so that movement of a first panel is transferred to a second panel or vice versa, via the device, and deflection of the first panel, the second panel, or both is minimized and/or substantially eliminated; and
wherein the connection region of the first part and the second part each include a torque transfer surface and the torque transfer surface of the first part and the torque transfer surface of the second art are twisted relative to each other so that the two torque transfer surfaces form an angle therebetween when the first part and the second part are connected.

2-22. (canceled)

23) The device of claim 1, wherein the second part, the first, part, or both include a connection region and one or more support regions.

24) The device of claim 1, wherein the two adjacent panels are made of oriented strand board (OSB) and form the roof of a building, and the device provides sufficient strength between the two adjacent panels so that deflection of the two adjacent panels is substantially reduced and/or eliminated so that one or more solar modules connected to the two adjacent panels are not deflected, flexed, damaged, broken, or a combination thereof.

25) The device of claim 1, wherein a force on one of the two adjacent panels causes contact between the torque transfer surface of the first part and the torque transfer surface of the second part so that movement of the first part is transferred to the second part or vice versa so that movement of the first part, the second part, the two adjacent panels, or a combination thereof are restricted.

26) The device of claim 25, wherein the torque transfer surface of the first part and the torque transfer surface of the second part when connected twist the support regions toward the two adjacent panels. so that the two adjacent panels are gripped between the support regions of the first part and the second part.

27) The device of claim 1, wherein the second part and the first part are identical and when connected together form an “X” shape, and the first part and the second part are two separate parts.

28) The device of claim 1, wherein the connection region of the second part and the first part each include an interlock so that when the second part and the first part are connected via the interlock, edges of the second part and the first part are flush, and the support regions of the first part and the second part extend in opposite directions from the connection region and the first part and the support regions are substantially parallel.

29) The device of claim 1, wherein the first part, the second part, or both when placed between the two adjacent panels has a support region that extends over at least one of the two adjacent panels and has a support region that extends under at least one of the two adjacent panels.

30) The device of claim 1, wherein the second part includes a threaded shaft and a washer, the threaded shaft extending through the washer and forming a threaded connection with the first part so that the washer is located above the two adjacent panels and the first part is located below the two adjacent panels.

31) The device of claim 1, wherein the one or more support regions of the second part include a gripping portion so that the one or more support regions when in contact with the two adjacent panels are substantially prevented from moving.

32) A method comprising:
a. placing the device of claim 1 in the seam between the two adjacent panels that are part of the pre-existing roof; and
b. securing the first part and the second part together so that the device restricts movement of the two adjacent panels relative to each other;
wherein the first part and the second part are both placed through the seam from a same side of the two adjacent panels before the first part and the second part are secured together.

33) The method of claim 32, wherein the two adjacent panels are part of a roof of a structure and one or more solar modules are supported on'the roof.

34) The method of claim 32, wherein the step of securing includes rotating the shaft so that a distance between the washer and the first part is reduced and the device is secured to the two adjacent panels.

35) The method of claim 32, wherein the first part and the second part are separately inserted between the two adjacent panels and the step of securing includes sliding the first part, the second part, or both into contact forming an interlock.

36) A device comprising.
a. a first part comprising:
i. a connecting region including an interlock and
ii. two spaced apart and substantially parallel support regions, wherein the connecting region is located between the two support regions and the two support regions extend in opposite directions and are substantially parallel,
b. a second part comprising:
i. a connecting region including an interlock and
ii. two spaced apart and substantially parallel support regions, wherein the connection region is located between the two support regions and the two support regions extend in opposite directions and are substantially parallel;
wherein the first part and the second part are separate parts;
wherein the connection region of the first part and the connection region of the second part are twisted so that during interlocking of the first part and the second part the support regions will twist towards the adjacent panels gripping he panels between the support regions of the first part and the second part:
wherein the first part and the second part are adapted to extend through a seam between two adjacent panels of a pre-existing roof without removing any panels of the roof and connect via the connection region so that one of the two spaced apart support regions of the first part and the second part are located above one of the two adjacent panels, and one of the two spaced apart support regions of the first part and the second part are located below one of the two adjacent panels.
